(19) United States
(12) Patent Application Publication
(10) Pub. No.: US 2023/0010370 A1
(43) Pub. Date: Jan. 12, 2023

(54) METHOD, COMMUNICATION DEVICE AND STORAGE MEDIUM FOR ALLOCATING COMMUNICATION RESOURCE UNITS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 17/781,766

(22) PCT Filed: Dec. 5, 2019
(86) PCT No.: PCT/CN2019/123395

§ 371 Date: Jun. 2, 2022

(51) Int. Cl. H04W 72/04

(52) U.S. Cl. CPC H04W 72/0453; H04W 72/042; H04W 72/046

(57) ABSTRACT

A communication resource unit allocation method, includes: receiving a message sent by a second radio communication device, wherein the message comprises an information element indicating a number of antennas of the second radio communication device.

### CROSS REFERENCE

The present application is a U.S. National Stage of International Application No. PCT/CN2019/123395, filed on Dec. 5, 2019, the contents of all of which are incorporated herein by reference in their entireties for all purposes.

### BACKGROUND

The Institute of Electrical and Electronics Engineers established a study group (SG) to research the next generation mainstream Wi-Fi technology. The research focuses on 320 MHz bandwidth transmission, multiple-frequency-band aggregation and collaboration, etc. As proposed in the vision, the rate and throughput will be improved by at least four times that of the existing IEEE802.11ax standard. The new technology is mainly applied to the fields of video transmission, augmented reality (AR), virtual reality (VR), etc.

### SUMMARY

According to a first aspect of the embodiments of the present disclosure, a communication resource unit allocation method is provided and applied to a first radio communication device, including:

receiving a message sent by a second radio communication device, where the message includes an information element indicating a number of antennas of the second radio communication device.

According to a second aspect of the embodiments of the present disclosure, a communication resource unit allocation method is provided and applied to a second radio communication device, including:

sending a message, where the message includes an information element indicating a number of antennas of the second radio communication device.

According to a third aspect of the embodiments of the present disclosure, provided is a communication device, including a processor, a transceiver, a memory, and an executable program stored on the memory and executable by the processor. The processor executes, when running the executable program, steps of the communication resource unit allocation method according to the first aspect.

According to a fourth aspect of the embodiments of the present disclosure, provided is a communication device including a processor, a transceiver, a memory, and an executable program stored on the memory and executable by the processor. The processor executes, when running the executable program, steps of the communication resource unit allocation method according to the second aspect.

According to a fifth aspect of the embodiments of the present disclosure, provided is a storage medium for storing an executable program. The executable program implements, when executed by a processor, the steps of the communication resource unit allocation method according to the first aspect.

According to a sixth aspect of the embodiments of the present disclosure, provided is a storage medium for storing an executable program. The executable program implements, when executed by a processor, the steps of the communication resource unit allocation method according to the second aspect.

It should be understood that both the foregoing general description and the following detailed description are illustrative and explanatory and are not restrictive of the embodiments of the present disclosure.

### BRIEF DESCRIPTION OF THE DRAWINGS

The accompanying drawings, which are incorporated into and constitute a part of this specification, illustrate embodiments consistent with the present disclosure and, together with the specification, serve to explain the principles of the embodiments of the present disclosure.

FIG. 1 is a flow diagram of a communication resource unit allocation method according to one example;

FIG. 2 is a structural schematic diagram of an information element according to one example;

FIG. 3 is a flow diagram of another communication resource unit allocation method according to one example;

FIG. 4 is a structural block diagram of composition of a communication resource unit allocation apparatus according to one example;

FIG. 5 is a structural block diagram of composition of another communication resource unit allocation apparatus according to one example; and

FIG. 6 is a block diagram of an apparatus used for communication resource unit allocation according to one example.

### DETAILED DESCRIPTION

Description will herein be made in detail of examples, instances of which are illustrated in the accompanying drawings. When the following description refers to the accompanying drawings, the same numbers in different accompanying drawings refer to the same or similar elements unless otherwise indicated. The implementation modes described in the following examples do not represent all implementation modes consistent with the embodiment of the present disclosure. Rather, they are merely instances of apparatus and methods consistent with some aspects of the embodiments of the present disclosure as described in detail in the appended claims.

The terms applied to the embodiments of the present disclosure are for the purpose of describing particular embodiments merely and are not intended to be restrictive of the embodiments of the present disclosure. As applied to the embodiments and the appended claims of the present disclosure, singular forms “a”, “said” and “the” are intended to include plural forms as well, unless the context clearly indicates otherwise. It should be understood that the term “and/or” as used herein refers to and encompasses any or all possible combinations of one or more of the associated listed items.

It should be understood that although the terms first, second, third, etc. may be employed in the embodiments of the present disclosure to describe various information, such information should not be limited to these terms. These terms are merely used to distinguish the same type of information from each other. For embodiment, first information may also be referred to as second information, and similarly, second information may also be referred to as first information, without departing from the scope of the embodiments of the present disclosure. The word “if” as used herein may be construed to mean “upon” or “when” or “in response to determining”, depending on the context.

One Wi-Fi data frame transmission resource includes a plurality of subcarriers, a secondary grouping which can be conducted in one Wi-Fi data frame transmission resource, a certain number of subcarriers which are defined as one resource unit (RU), and each RU can provide a transmission resource for one terminal, so that each data frame is divided into a plurality of parts, and transmission resources can be provided for a plurality of users simultaneously.

An execution main body involved in the embodiments of the present disclosure includes, but is not limited to: a network device within a radio communication network, especially a Wi-Fi network operating in accordance with a standard such as an IEEE802.11a/b/g/n/ac standard, and under an IEEE802.11be standard in a next-generation Wi-Fi network, and the network device includes, but is not limited to: an access point (AP), a station (STA), etc.

The present disclosure relates to the technical field of radio communication, but is not limited to the technical field of radio communication, and particularly relates to a method, communication device and storage medium for allocating communication resource units.

One implementation scenario of the embodiments of the present disclosure conforms to an IEEE802.11ax standard in that only one resource unit (RU) may be allocated to a station one time under a certain bandwidth. In order to improve the use efficiency of a spectrum, two or more RUs may be allocated to one station under a certain bandwidth in IEEE802.11be, and the number of the RU which may be allocated to one station is not determined.

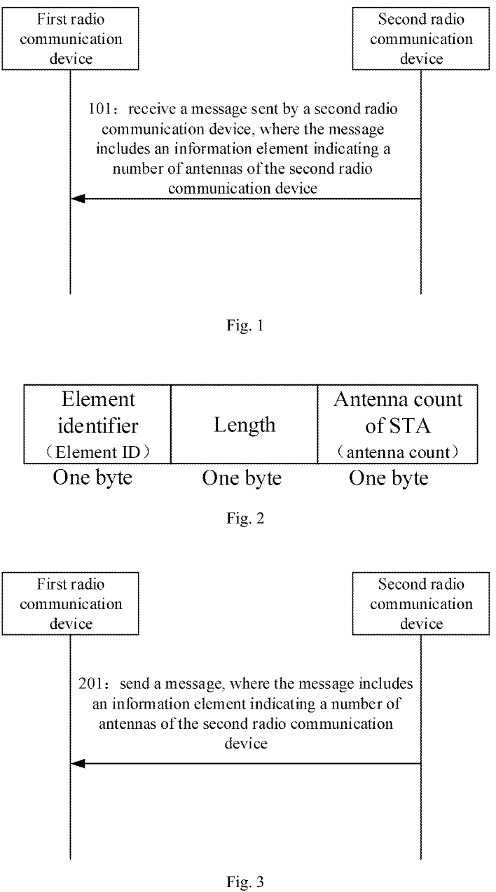

As shown in FIG. 1, the embodiment provides a communication resource unit allocation method applicable to a first radio communication device of radio communication. The method includes:

step 101: receive a message sent by a second radio communication device, where the message includes an information element indicating a number of antennas of the second radio communication device.

Herein, the first radio communication device may be an access point (AP) in a Wi-Fi communication technology, and the second radio communication device may be a station (STA) in a Wi-Fi communication technology.

In this embodiment of the present disclosure, the message may be a message frame. In some embodiments, the message may be a management frame and/or a data frame. Certainly, the message may also be in any appropriate manner, which is not limited in the embodiments of the present disclosure.

In some embodiments, the message may be a management frame send from the first radio communication device in the Wi-Fi communication technology.

Illustratively, the management frame may include: a probe request frame, an association request frame, or an authorization request frame, etc. The information element is a basic information unit for setting indication information in the message.

In some embodiments, the message may also be a data frame.

The second radio communication device and the first radio communication device send management frames to each other during association or re-association. The second radio communication device may send to the first radio communication device, a message comprising an information element including the number of antennas of the second radio communication device during association or re-association. In this way, the first radio communication device may determine the number of antennas of the second radio communication device from the message. The information element including the number of antennas of the second radio communication device may be a newly applied information element. The station is associated with the access point so as to gain full access to the network. Association belongs to a record keeping process and enables an AP to record the station, so as to send a message, transmitted to the station, to the correct station. Re-association refers to a process of performing association again after the station and the access point are out of an association relation.

The second radio communication device may be provided with two or more antennas. Different antennas may point in different directions, and the antennas with different directions may concentrate energy in a desired transmission direction when sending a signal so as to improve signal transmission performance, and may receive signals in different directions when receiving the signals so as to enhance a reception effect.

The first radio communication device may determine data transmission capability of the second radio communication device according to the number of antennas supported by the second radio communication device, and the data transmission capability serves as a basis for subsequent operations such as beam forming.

In this way, the second radio communication device indicates the number of antennas of the second radio communication device by means of the information element in the message, so as to provide an explicit indication of the number of antennas, and the first radio communication device may determine the number of antennas of the second radio communication device according to indication information of the information element; and the number of antennas of the second radio communication device may be used for marking communication capabilities such as beam forming of the second radio communication device, so as to improve the identification efficiency of the first radio communication device on the communication capability of the second radio communication device.

In some embodiments, the method further includes: determine the number of resource units (RU) allocated to the second radio communication device according to the number of antennas of the second radio communication device.

Herein, the RU may be a transmission resource composed of two or more subcarriers. In the IEEE802.11 ax standard, supported RU formats include: 26-tone, 52-tone, 106-tone, 242-tone, 484-tone, 996-tone, or 2*996-tone.

The first radio communication device and the second communication device may perform beam forming on a carrier of each RU when using the RU for data interaction. Beam forming is related to the number of antennas, and generally, only one antenna may be occupied when a carrier with a contiguous bandwidth is subjected to beam forming. Thus, the number of antennas may determine the number of the carrier with a contiguous bandwidth, and further determine the number of the RU.

Illustratively, the first radio communication device may allocate the same number of the RU as the number of antennas to the second communication device. In this way, the carrier of each RU may occupy one antenna to be subject to beam forming.

In this way, the number of antennas of the second radio communication device is taken as a basis of RU allocation, such that the allocation of the RU matches the number of antennas of the second radio communication device, the situation that the number of the discontiguous carrier is greater than the number of antennas is avoided, accuracy of RU allocation is improved, and reliability of data transmission is improved.

In some embodiments, the step of determining the number of RUs allocated to the second radio communication device according to the number of antennas of the second radio communication device includes:

determining, if the two or more RUs allocated to the second radio communication device are discontiguous in a frequency domain, that the number of the RU allocated to the second radio communication device is less than or equal to the number of antennas of the second radio communication device.

In an operation bandwidth, a first radio communication device may allocate two or more RUs to the second radio communication device, and the two or more RUs may be contiguous in the frequency domain or not.

If each allocated RU is completely discontiguous or partially discontiguous in the frequency domain, beam forming needs to be performed on a carrier of each discontiguous RU separately, and the contiguous RUs may be subject to beam forming together or separately. Since the carrier of one bandwidth needs to occupy one antenna during beam forming, that is, each RU needs to occupy one antenna, the maximum number of the RU allocated to the second radio communication device by the first radio communication device is equal to the number of antennas of the second radio communication device, that is, the number of the RU that the first radio communication device may allocate is less than or equal to the number of antennas of the second radio communication device.

In this way, on one hand, the allocation of the RU better accords with actual transmission conditions, accuracy of the RU allocation is improved, and the reliability of data transmission is improved. On the other hand, when the second radio communication device is provided with two or more antennas, two or more RUs may be allocated to the second radio communication device, so as to improve a spectrum use rate, and further to improve a transmission throughput.

In some embodiments, the step of determining the number of RUs allocated to the second radio communication device according to the number of antennas of the second radio communication device includes:

determining, according to the number of antennas of the second radio communication device, the number of the RU allocated to the second radio communication device in a bandwidth.

The second radio communication device may support operation at different operation bandwidths such as 20 MHz, 40 MHz, 80 MHz, 160 MHz, 160 MHz+80 MHz, 160 MHz+160 MHz, or 320 MHz, etc. The number of the RU allocated to the second radio communication device may be the number of the RU at one operation bandwidth. For embodiment, the first radio communication device may determine the number of the RU at 20 MHz operation bandwidth of the second radio communication device according to the number of antennas of the second radio communication device.

In some embodiments, the method further includes as least one of the following:
perform beam forming on a carrier of each discontiguous RU separately if the two or more RUs allocated to the second radio communication device are discontiguous in a frequency domain;
combine the carriers of two or more RUs for beam forming if the two or more RUs allocated to the second radio communication device are contiguous in a frequency domain and a sum of subcarriers included in the two or more RUs is equal to a first subcarrier number; and
perform beam forming on a carrier of each of two or more RUs separately if the two or more RUs allocated to the second radio communication device are contiguous in the frequency domain and a sum of subcarriers included in the two or more RUs is greater than or less than a first subcarrier number.

Herein, the first subcarrier number may be any one of seven subcarrier numbers including 26, 52, 106, 242, 484, 996, and 2*996 included in the RU formats supported by the IEEE802.11ax standard. That is, in the IEEE802.11ax standard, the number of the subcarriers in an RU that may be transmitted may be only any of the seven subcarrier numbers described above.

In some embodiments, the step of combining the carriers of two or more RUs for beam forming may be combining the carriers of two or more RUs into one carrier and then performing beam forming on the one carrier.

In the operation bandwidth, the first radio communication device may allocate two or more RUs to the second radio communication device, the RUs may be contiguous in the frequency domain or not, or part of the RUs may be contiguous in the frequency domain and part of the RUs may be discontiguous in the frequency domain.

If each allocated RU is discontiguous in the frequency domain or part of the RUs are discontiguous in the frequency domain, beam forming needs to be performed on carriers of the discontiguous RUs separately. Since the carrier of one bandwidth needs to occupy one antenna during beam forming, that is, each of the discontiguous RUs needs to occupy one antenna, the first radio communication device or the second radio communication device needs to perform beam forming on the carrier of each RU separately.

Illustratively, the first radio communication device allocates two RUs discontiguous in the frequency domain to the second radio communication device, one RU includes 26 subcarriers and the other one includes 52 subcarriers, and the first radio communication device or the second radio communication device may perform beam forming on the two RUs respectively.

If two or more RUs allocated to the second radio communication device by the first radio communication device are contiguous in the frequency domain, and the sum of the number of the subcarriers of the two or more RUs is any one of the seven subcarrier numbers included in the RU formats supported by the IEEE802.11ax standard, the carriers of the two or more RUs may be subjected to beam forming together and sent by one antenna.

Illustratively, the two RUs allocated to the second radio communication device by the first radio communication device are contiguous in the frequency domain, and the two RUs include 26 and 26 subcarriers respectively. The sum of subcarriers included in the two RUs is 52, which is one of the seven subcarrier numbers included in the RU formats supported by the IEEE802.11ax standard, such that the carriers of the RUs may be subjected to beam forming together and sent by one antenna.

If two or more RUs allocated to the second radio communication device by the first radio communication device are contiguous in the frequency domain, and the sum of subcarriers of the two or more RUs is not any one of the seven subcarrier numbers included in the RU formats supported by the IEEE802.11ax standard, the first radio communication device or the second radio communication device may perform beam forming on the carrier of each RU separately.

Illustratively, the first radio communication device allocates two RUs contiguous in the frequency domain to the second radio communication device, one RU includes 26 subcarriers, the other RU includes 52 subcarriers, and the sum of the total number of the subcarriers included in the two RUs is 78 subcarriers, which is none of the seven subcarrier numbers included in the RU formats supported by the IEEE802.11ax standard; and in such a case, in order to be compatible with the IEEE802.11ax standard, the first radio communication device or the second radio communication device may perform beam forming on the carriers of the two RUs separately.

Certainly, if the RU format supported in the IEEE802.11ax standard changes, the first subcarrier number in all embodiments of the present disclosure may also be adjusted accordingly, which is not limited in the embodiments of the present disclosure. Certainly, the first subcarrier number may also be determined in other ways, which is also not limited in the present disclosure. When the first radio communication device and the second radio communication device in the embodiments of the present disclosure do not comply with the IEEE802.11ax standard, the parameter of first subcarrier number may not need to be set, that is, the method in the embodiment of the present disclosure includes:

performing beam forming on carriers of the discontiguous RUs separately if each allocated RU is discontiguous in the frequency domain or part of the RUs are discontiguous in the frequency domain. Since the carrier of one bandwidth needs to occupy one antenna during beam forming, that is, each of the discontiguous RUs needs to occupy one antenna, the first radio communication device or the second radio communication device needs to perform beam forming on the carrier of each RU separately.

In this way, the RU employed by the first radio communication device for the second radio communication device may be compatible with the IEEE802.11ax standard, thereby improving data transmission compatibility.

If two or more resource units allocated to the second radio communication device are contiguous in the frequency domain, carriers of the two or more resource units are combined to be subject to beam forming. That is, beam forming is performed on carriers together when two or more RUs are contiguous in the frequency domain, regardless of the total number of subcarriers included in the carriers of the two or more RUs.

In some embodiments, the information element includes at least one of the following: an information element identifier for identifying the information element; a length identifier for indicating a length of the information element; and an antenna count identifier for indicating the number of antennas of the second radio communication device.

As shown in FIG. 2, illustratively, the information element may occupy three bytes. The information element identifier may occupy one byte, and the information element identifier is used for identifying the information element. The length identifier may occupy one byte. The number of antennas identifier occupies one byte, and may use a binary number to represent the number of antennas.

As shown in FIG. 3, the embodiment provides a communication resource unit allocation method applicable to a second radio communication device of radio communication. The method includes:

step 201: send a message, where the message includes an information element indicating a number of antennas of the second radio communication device.

Herein, the first radio communication device may be an access point (AP) in a Wi-Fi communication technology, and the second radio communication device may be a station (STA) in a Wi-Fi communication technology.

In this embodiment of the present disclosure, the message may be a message frame. In some embodiments, the message may be a management frame and/or a data frame. Certainly, the message may also be constructed in any appropriate manner, which is not limited in the embodiments of the present disclosure.

In some embodiments, the message may be a management frame send from the first radio communication device in the Wi-Fi communication technology.

Illustratively, the message may include: a probe request frame, an association request frame, or an authorization request frame, etc. The information element is a basic information unit for setting indication information in the message.

Illustratively, the message may also be a data frame.

The second radio communication device and the first radio communication device send management frames to each other during association or re-association. The second radio communication device may send the first radio communication device a message of an information element including the number of antennas of the second radio communication device during association or re-association. In this way, the first radio communication device may determine the number of antennas of the second radio communication device from the message. The information element including the number of antennas of the second radio communication device may be a newly applied information element. The station is associated with the access point so as to gain full access to the network. Association belongs to a record keeping process and enables an AP to record the station, so as to send a message, transmitted to the station, to the correct station. Re-association refers to a process of performing association again after the station and the access point are out of an association relation.

The second radio communication device may be provided with two or more antennas, different antennas may point in different directions, and the antennas with different directions may concentrate energy in a desired transmission direction when sending a signal so as to improve signal transmission performance, and may receive signals in different directions when receiving the signals so as to enhance a reception effect.

The first radio communication device may determine data transmission capability of the second radio communication device according to the number of antennas supported by the second radio communication device, and the data transmission capability serves as a basis for subsequent operations such as beam forming.

In this way, the second radio communication device indicates the number of antennas of the second radio communication device by means of the information element in the message, so as to provide an explicit indication mode of the number of antennas. The first radio communication device may determine the number of antennas of the second radio communication device according to indication information of the information element; and the number of antennas of the second radio communication device may be used for marking communication capabilities such as beam forming of the second radio communication device, so as to improve identification efficiency of the first radio communication device on the communication capability of the second radio communication device.

In some embodiments, the number of RUs allocated to the second radio communication device is determined according to the number of antennas.

Herein, the RU may be a transmission resource composed of two or more subcarriers. In IEEE802.11ax, supported RU formats include: 26-tone, 52-tone, 106-tone, 242-tone, 484-tone, 996-tone, or 2*996-tone.

The first radio communication device and the second communication device may perform beam forming on a carrier of each RU when using the RU for data interaction. Beam forming is related to the number of antennas, and generally, one antenna needs to be occupied when a carrier with a contiguous bandwidth is subjected to beam forming. Thus, the number of antennas may determine the number of the carrier with a contiguous bandwidth, and further determine the number of the RU.

Illustratively, the first radio communication device may allocate the same number of the RU as the number of antennas to the second communication device. In this way, the carrier of each RU may occupy one antenna to be subject to beam forming.

In this way, the number of antennas of the second radio communication device is taken as a basis of RU allocation, such that the allocation of the RU matches the number of antennas of the second radio communication device, the situation that the number of the discontiguous carrier is greater than the number of antennas is avoided, accuracy of RU allocation is improved, and reliability of data transmission is improved.

In the operation bandwidth, the first radio communication device may allocate two or more RUs to the second radio communication device, the RUs may be contiguous in the frequency domain or not, or part of the RUs may be contiguous in the frequency domain and other RUs may be discontiguous in the frequency domain.

If two or more allocated RUs are discontiguous in the frequency domain, beam forming needs to be performed on a carrier of each discontiguous RU separately, and the contiguous RUs may be subject to beam forming together or separately. Since the carrier of one bandwidth needs to occupy one antenna during beam forming, that is, each RU needs to occupy one antenna, the maximum number of the RU allocated to the second radio communication device by the first radio communication device is equal to the number of antennas of the second radio communication device, that is, the number of the RU that the first radio communication device may allocate is less than or equal to the number of antennas of the second radio communication device.

In this way, on one hand, the allocation of the RU better accords with actual transmission conditions, accuracy of the RU allocation is improved, the RU allocation matches the number of antennas of the second radio communication device, the situation that the number of discontinuous carrier is greater than the number of antennas is avoided, the accuracy of RU allocation is improved, and the reliability of data transmission is improved. On the other hand, when the second radio communication device is provided with two or more antennas, two or more RUs may be allocated to the second radio communication device, so as to improve a spectrum use rate, and further to improve a transmission throughput.

In some embodiments, the information element includes at least one of the following: an information element identifier for identifying the information element; a length identifier for indicating a length of the information element; and an antenna count identifier for indicating the number of antennas of the second radio communication device.

As shown in FIG. 2, illustratively, the information element may occupy three bytes. The information element identifier may occupy one byte, and the information element identifier is used for identifying the information element. The length identifier may occupy one byte. The number of antennas identifier occupies one byte, and may use a binary number to represent the number of antennas.

In some embodiments, the method further includes as least one of the following:
perform beam forming on a carrier of each discontiguous RU separately if the two or more RUs allocated to the second radio communication device are discontiguous in a frequency domain;
combine the carriers of two or more RUs for beam forming if the two or more RUs allocated to the second radio communication device are contiguous in a frequency domain and a sum of subcarriers included in the two or more RUs is equal to a first subcarrier number; and
perform beam forming on a carrier of each of two or more RUs separately if the two or more RUs allocated to the second radio communication device are contiguous in the frequency domain and a sum of subcarriers included in the two or more RUs is greater than or less than a first subcarrier number.

Herein, the first subcarrier number may be any one of seven subcarrier numbers including 26, 52, 106, 242, 484, 996, and 2*996 included in the RU formats supported by the IEEE802.11ax standard. That is, in the IEEE802.11ax standard, the number of the subcarriers in an RU that may be transmitted may be only any of the seven subcarrier numbers described above.

In some embodiments, the step of combining the carriers of two or more RUs for beam forming may be combining the carriers of two or more RUs into one carrier and then performing beam forming on the one carrier.

In the operation bandwidth, the first radio communication device may allocate two or more RUs to the second radio communication device, the RUs may be contiguous in the frequency domain or not, or part of the RUs may be contiguous in the frequency domain and part of the RUs may be discontiguous in the frequency domain.

If each allocated RU is discontiguous in the frequency domain or part of the RUs are discontiguous in the frequency domain, beam forming needs to be performed on carriers of the discontiguous RUs separately. Since the carrier of one bandwidth needs to occupy one antenna during beam forming, that is, each of the discontiguous RUs needs to occupy one antenna, the first radio communication device or the second radio communication device needs to perform beam forming on the carrier of each RU separately.

Illustratively, the first radio communication device allocates two RUs discontiguous in the frequency domain to the second radio communication device, one RU includes 26 subcarriers and the other one includes 52 subcarriers, and the first radio communication device or the second radio communication device may perform beam forming on the two RUs respectively.

If two or more RUs allocated to the second radio communication device by the first radio communication device are contiguous in the frequency domain, and the sum of the number of the subcarriers of the two or more RUs is any one of the seven subcarrier numbers included in the RU formats supported by the IEEE802.11ax standard, the carriers of the two or more RUs may be subjected to beam forming together and sent by one antenna.

Illustratively, the two RUs allocated to the second radio communication device by the first radio communication device are contiguous in the frequency domain, and the two RUs include 26 and 26 subcarriers respectively. The sum of subcarriers included in the two RUs is 52, which is one of the seven subcarrier numbers included in the RU formats supported by the IEEE802.11ax standard, such that the carriers of the RUs may be subjected to beam forming together and sent by one antenna.

If two or more RUs allocated to the second radio communication device by the first radio communication device are contiguous in the frequency domain, and the sum of subcarriers of the two or more RUs is not any one of the seven subcarrier numbers included in the RU formats supported by the IEEE802.11ax standard, the first radio communication device or the second radio communication device may perform beam forming on the carrier of each RU separately.

Illustratively, the first radio communication device allocates two RUs contiguous in the frequency domain to the second radio communication device, one RU includes 26 subcarriers, the other RU includes 52 subcarriers, and the sum of the total number of the subcarriers included in the two RUs is 78 subcarriers, which is none of the seven subcarrier numbers included in the RU formats supported by the IEEE802.11ax standard; and in such a case, in order to be compatible with the IEEE802.11ax standard, the first radio communication device or the second radio communication device may perform beam forming on the carriers of the two RUs separately.

Certainly, if the RU format supported in the IEEE802.11ax standard changes, the first subcarrier number in all embodiments of the present disclosure may also be adjusted therewith, which is not limited in the embodiments of the present disclosure. When the first radio communication device and the second radio communication device in the embodiments of the present disclosure do not comply with the IEEE802.11ax standard, the parameter of first subcarrier number may not need to be set, that is, the method in the embodiment of the present disclosure includes:

perform beam forming on carriers of the discontiguous RUs separately if each allocated RU is discontiguous in the frequency domain or part of the RUs are discontiguous in the frequency domain. Since the carrier of one bandwidth needs to occupy one antenna during beam forming, that is, each of the discontiguous RUs needs to occupy one antenna, the first radio communication device or the second radio communication device needs to perform beam forming on the carrier of each RU separately.

In this way, the RU employed by the first radio communication device for the second radio communication device may be compatible with the IEEE802.11ax standard, thereby improving data transmission compatibility.

If two or more resource units allocated to the second radio communication device are contiguous in the frequency domain, carriers of the two or more resource units are combined to be subject to beam forming. That is, beam forming is performed on carriers together when two or more RUs are contiguous in the frequency domain, regardless of the total number of subcarriers included in the carriers of the two or more RUs.

A specific embodiment is provided below in conjunction with any one of the embodiments described above:
1. Consideration of maximum number of RU allocation
   a. under one transmission bandwidth, an access point allocates a certain number of RUs to a station, beam forming is performed between the station and the access point before communication, if the allocation of each RU is discontiguous, or if the allocation of the RU is continuous but the sum of the number of a subcarrier of the RU is incompatible with an IEEE802.11ax regulation, the allocated RU may be separately regarded as one channel for communication. The access point performs beam forming on each RU before communication, and since the beam forming relates to the number of antennas supported by the station, the maximum number of the RUs allocated by the access point to the station is the maximum number of the antennas supported by the station; and when beam forming is performed, a Null data packet (NDP) may first be sent as a sounding frame for beam forming.
   b. compatibility

In the existing IEEE802.11ax, supported RU formats include: 26-(subcarrier) tone, 52-tone, 106-tone, 242-tone, 484-tone, 996-tone, and 2*996-tone. If contiguous RUs allocated to a station in one bandwidth are 26-tone and 52-tone, but considering compatibility, the RUs may only two channels during beam forming, and if two 26-tones are allocated consecutively, the RUs may serve as one channel for beam forming. Herein, the station may operate in a bandwidth of 20 MHz, 40 MHz, 80 MHz, 160 MHz, 160 MHz+80 MHz, 160 MHz+160 MHz, or 320 MHz. Certainly, when the IEEE802.11ax does not need to be compatible, the restriction of IEEE802.11ax on the RU format does not need to be considered, and how to perform beam forming may be determined only according to whether the allocated RUs are contiguous.

During interaction between the station and the access point, a capability information value of supporting a maximum number of the antenna by the station is sent to the access point, specifically, the capability information value may be carried in a form of an information element in a probe request frame, an association request frame or an authentication request frame, and the specific format of the information element may be shown in FIG. 2. An element identifier (element ID) defines an information element as a new information element, and the information element identifies a maximum number of the antennas supported by the station.

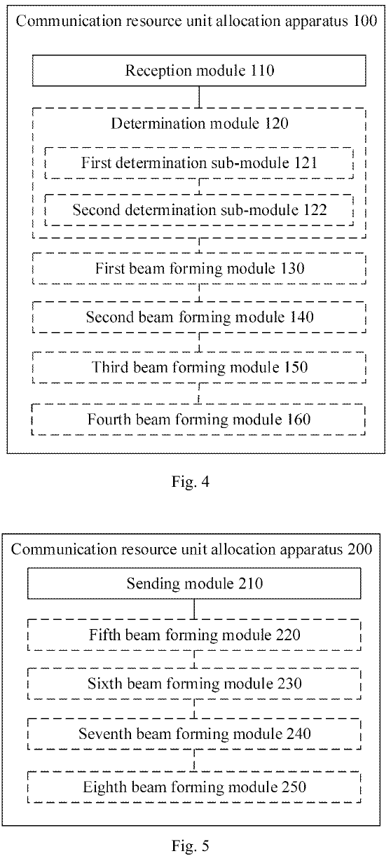

The embodiment of the present disclosure further provides a communication resource unit allocation apparatus, applied to a first radio communication device. FIG. 4 is a structural schematic diagram of composition of the communication resource unit allocation apparatus 100 provided in the embodiment of the present disclosure. As shown in FIG. 4, the apparatus 100 includes: a reception module 110, where

the reception module 110 is configured to receive a message sent by a second radio communication device, where the message includes an information element indicating a number of antennas of the second radio communication device.

In some embodiments, the apparatus 100 further includes:

a determination module 120 configured to determine the number of resource units allocated to the second radio communication device according to the number of antennas of the second radio communication device.

In some embodiments, the determination module 120 includes:

a first determination sub-module 121 configured to determiningif the two or more resource units allocated to the second radio communication device are discontiguous in a frequency domain, that the number of the resource units allocated to the second radio communication device is less than or equal to the number of antennas of the second radio communication device.

In some embodiments, the determination module 120 includes:

a second determination sub-module 122 configured to determining, according to the number of antennas of the second radio communication device, the number of the resource units allocated to the second radio communication device in a present bandwidth.

In some embodiments, the apparatus 100 further includes:

a first beam forming module 130 configured to perform beam forming on a carrier of each discontiguous resource unit separately if the two or more resource units allocated to the second radio communication device are discontiguous in a frequency domain.

In some embodiments, the apparatus 100 further includes:

a second beam forming module 140 configured to combine the carriers of two or more resource units for beam forming if the two or more resource units allocated to the second radio communication device are contiguous in a frequency domain and a sum of subcarriers included in the two or more resource units is equal to a first subcarrier number.

In some embodiments, the apparatus 100 further includes:

a third beam forming module 150 configured to perform beam forming on a carrier of each of two or more resource units separately if the two or more resource units allocated to the second radio communication device are contiguous in the frequency domain and a sum of subcarriers included in the two or more resource units is greater than or less than a first subcarrier number.

In some embodiments, the apparatus 100 further includes:

a fourth beam forming module 160 configured to combine the carriers of two or more resource units for beam forming if the two or more resource units allocated to the second radio communication device are contiguous in the frequency domain.

In some embodiments, the information element includes at least one of the following:
an information element identifier for identifying the information element;
a length identifier for indicating a length of the information element; and
an antenna count identifier for indicating the number of antennas of the second radio communication device.

The embodiment of the present disclosure further provides a communication resource unit allocation apparatus, applied to a second radio communication device. FIG. 5 is a structural schematic diagram of composition of the communication resource unit allocation apparatus 200 provided in the embodiment of the present disclosure. As shown in FIG. 5, the apparatus 200 includes: a sending module 210, where

the sending module 210 is configured to send a message to a first radio communication device, and the message includes an information element indicating a number of antennas of the second radio communication device.

In some embodiments, the number of resource units allocated to the second radio communication device is determined according to the number of antennas.

In some embodiments, the information element includes at least one of the following:
an information element identifier for identifying the information element;
a length identifier for indicating a length of the information element; and
an antenna count identifier for indicating the number of antennas of the second radio communication device.

In some embodiments, the apparatus 200 further includes:

a fifth beam forming module 220 configured to perform beam forming on a carrier of each discontiguous resource unit separately if the two or more resource units allocated to the second radio communication device are discontiguous in a frequency domain.

In some embodiments, the apparatus 200 further includes:

a sixth beam forming module 230 configured to combine the carriers of two or more resource units for beam forming if the two or more resource units allocated to the second radio communication device are contiguous in a frequency domain and a sum of subcarriers included in the two or more resource units is equal to a first subcarrier number.

In some embodiments, the apparatus 200 further includes:

a seventh beam forming module 240 configured to perform beam forming on a carrier of each of two or more resource units separately if the two or more resource units allocated to the second radio communication device are contiguous in the frequency domain and a sum of subcarriers included in the two or more resource units is greater than or less than a first subcarrier number.

In some embodiments, the apparatus 200 further includes:

an eighth beam forming module 250 configured to combine the carriers of two or more resource units for beam forming if the two or more resource units allocated to the second radio communication device are contiguous in the frequency domain.

In the embodiments, the reception module 110, the determination module 120, the first beam forming module 130, the second beam forming module 140, the third beam forming module 150, the fourth beam forming module 160, the sending module 210, the fifth beam forming module 220, the sixth beam forming module 230, the seventh beam forming module 240, the eighth beam forming module 250, etc. may be implemented by one or more central processing units (CPUs), a graphics processing unit (GPU), a baseband processor (BP), an application specific integrated circuit (ASIC), a digital signal processor (DSP), a programmable logic device (PLD), a complex programmable logic device (CPLD), a field-programmable gate array (FPGA), a general-purpose processor, a controller, a micro controller unit (MCU), a microprocessor, or other electronic components, so as to execute the method described above.

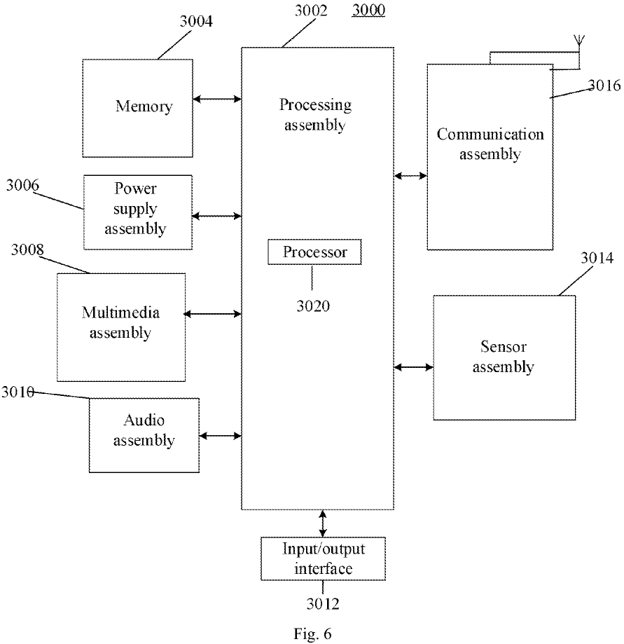

FIG. 6 is a block diagram of an apparatus 3000 used for communication resource unit allocation or transmission block configuration parameter determination according to one example. For embodiment, the apparatus 3000 may be a mobile phone, a computer, a digital broadcast terminal, a messaging device, a gaming console, a tablet device, a medical device, a fitness device, a personal digital assistant, etc.

With reference to FIG. 6, the apparatus 3000 may include one or more of a processing assembly 3002, a memory 3004, a power supply assembly 3006, a multimedia assembly 3008, an audio assembly 3010, an input/output (I/O) interface 3012, a sensor assembly 3014, and a communication assembly 3016.

The processing assembly 3002 generally controls overall operation of the apparatus 3000 such as operations associated with display, phone calls, data communications, camera operations, and recording operations. The processing assembly 3002 may include one or more processors 3020 to execute an instruction to complete all or some of the steps of the method described above. Moreover, the processing assembly 3002 may include one or more modules to facilitate interaction between the processing assembly 3002 and other assemblies. For embodiment, the processing assembly 3002 may include the multimedia module to facilitate interaction between the multimedia assembly 3008 and the processing assembly 3002.

The memory 3004 is configured to store various types of data to support operation on the apparatus 3000. Instances of such data include an instruction, operated on the apparatus 3000, for any application or method, contact data, phonebook data, messages, pictures, video, etc. The memory 3004 may be implemented by any type of volatile or non-volatile memory apparatus, or a combination thereof such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply assembly 3006 provides power for the various assemblies of the apparatus 3000. The power supply assembly 3006 may include a power management system, one or more power supplies, and other assemblies associated with power generating, managing, and distributing for the apparatus 3000.

The multimedia assembly 3008 includes a screen that provides an output interface between the apparatus 3000 and the user. In some embodiments, the screen may include a liquid crystal display (LCD) and a touch panel (TP). Under the condition that the screen includes the touch panel, the screen may be implemented as a touch screen to receive an input signal from the user. The touch panel includes one or more touch sensors to sense touches, slides, and gestures on the touch panel. The touch sensor may not only sense a boundary of a touch or swipe action, but also detect duration and pressure related to the touch or swipe operation. In some embodiments, the multimedia assembly 3008 includes a front-facing camera and/or a rear-facing camera. When the apparatus 3000 is in an operational mode, for instance, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio assembly 3010 is configured to output and/or input an audio signal. For embodiment, the audio assembly 3010 includes a microphone (MIC) configured to receive an external audio signal when the apparatus 3000 is in the operational mode such as a calling mode, a recording mode, and a speech recognition mode. The received audio signal may be further stored in the memory 3004 or transmitted via the communication assembly 3016. In some embodiments, the audio assembly 3010 further includes a speaker for outputting the audio signal.

The I/O interface 3012 provides an interface between the processing assembly 3002 and a peripheral interface module, which may be a keyboard, a click wheel, a button, etc. These buttons may include, but are not limited to, a home button, a volume button, a start button, and a lock button.

The sensor assembly 3014 includes one or more sensors for providing state assessments of various aspects for the apparatus 3000. For embodiment, the sensor assembly 3014 may detect an on/off state of the apparatus 3000 and relative positioning of the assemblies. For embodiment, the assemblies are a display and a keypad of the apparatus 3000. The sensor assembly 3014 may also detect a change in position of the apparatus 3000 or an assembly of the apparatus 3000, the presence or absence of contact between the user and the apparatus 3000, orientation or acceleration/deceleration of the apparatus 3000, and temperature variation of the apparatus 3000. The sensor assembly 3014 may include a proximity sensor configured to detect presence of nearby objects in the absence of any physical contact. The sensor assembly 3014 may also include a light sensor, for instance, a complementary metal oxide semiconductor (CMOS) or charge coupled device (CCD) image sensor, for use in imaging applications. In some embodiments, the sensor assembly 3014 may also include an acceleration sensor, a gyroscopic sensor, a magnetic sensor, a pressure sensor, or a temperature sensor.

The communication assembly 3016 is configured to facilitate communications between the apparatus 3000 and other device in a wired or radio mode. The apparatus 3000 may access a radio network based on a communication standard such as Wi-Fi, 2G, or 3G, or a combination thereof. In one example, the communication assembly 3016 receives a broadcast signal or broadcast related information from an external broadcast management system via a broadcast channel. In one example, the communication assembly 3016 also includes a near field communication (NFC) module to facilitate short-range communication. For embodiment, the NFC module may be implemented based on a radio frequency identification (RFID) technology, an infrared data association (IrDA) technology, an ultra wide band (UWB) technology, a bluetooth (BT) technology, and other technologies.

In the example, the apparatus 3000 may be implemented by one or more application specific integrated circuits (ASIC), a digital signal processor (DSP), a digital signal processing device (DSPD), a programmable logic device (PLD), a field programmable gate array (FPGA), a controller, a microcontroller, a microprocessor, or other electronic elements for executing the method above.

In the example, further provided is a non-transitory computer-readable storage medium including an instruction such as a memory 3004 including an instruction, and the instruction may be executed by the processor 3020 of the apparatus 3000 so as to execute the method above. For embodiment, the non-transitory computer-readable storage medium may be a read-only memory (ROM), a random access memory (RAM), a compact disc read-only memory (CD-ROM), a magnetic tape, a floppy disk, an optical data storage device, etc.

Other implementation solutions of the embodiments of the present disclosure will readily occur to those skilled in the art upon consideration of the specification and practical disclosure. The present disclosure is intended to cover any variations, uses, or adaptations of the embodiments of the present disclosure, and these variations, uses, or adaptations follow general principles of the embodiments of the present disclosure and include common general knowledge or customary technical means in the technical field not disclosed in the embodiments of the present disclosure. The specification and embodiments are considered as illustrative merely, and a true scope and spirit of the embodiments of the present disclosure are indicated by the following claims.

It should be understood that the embodiments of the present disclosure are not limited to the precise structure that has been described above and shown in the accompanying drawings, and that various modifications and changes may be made without departing from its scope. The scope of the embodiments of the present disclosure is limited only by the appended claims.

According to a first aspect of the embodiments of the present disclosure, a communication resource unit allocation method is provided and applied to a first radio communication device, including:

receiving a message sent by a second radio communication device, where the message includes an information element indicating a number of antennas of the second radio communication device.

In some embodiments, the method further includes:

determining the number of resource units allocated to the second radio communication device according to the number of antennas of the second radio communication device.

In some embodiments, the determining the number of resource units allocated to the second radio communication device according to the number of antennas of the second radio communication device includes:

determining, if the two or more resource units allocated to the second radio communication device are discontiguous in a frequency domain, that the number of the resource units allocated to the second radio communication device is less than or equal to the number of antennas of the second radio communication device.

In some examples, the determining the number of a resource unit allocated to the second radio communication device according to the number of antennas of the second radio communication device includes:

determining, according to the number of antennas of the second radio communication device, the number of the resource units allocated to the second radio communication device in a bandwidth.

In some embodiments, the method further includes:

performing beam forming on a carrier of each discontiguous resource unit separately if the two or more resource units allocated to the second radio communication device are discontiguous in a frequency domain.

In some embodiments, the method further includes:
combining the carriers of a plurality of resource units for beam forming if the two or more resource units allocated to the second radio communication device are contiguous in the frequency domain and a sum of subcarriers included in the plurality of resource units is equal to a first subcarrier number; and
in some embodiments, the method further includes: performing beam forming on a carrier of each of two or more resource units if the two or more resource units allocated to the second radio communication device are contiguous in the frequency domain and a sum of subcarriers included in the two or more resource units is greater than or less than a first subcarrier number.

In some embodiments, the method further includes:

combining the carriers of two or more resource units for beam forming if the two or more resource units allocated to the second radio communication device are contiguous in the frequency domain.

In some embodiments, the information element includes at least one of the following:
an information element identifier for identifying the information element;
a length identifier for indicating a length of the information element; and
an antenna count identifier for indicating the number of antennas of the second radio communication device.

According to a second aspect of the embodiments of the present disclosure, a communication resource unit allocation method is provided and applied to a second radio communication device, including:

sending a message, where the message includes an information element indicating a number of antennas of the second radio communication device.

In some embodiments, the number of resource units allocated to the second radio communication device is determined according to the number of antennas.

In some embodiments, the information element includes at least one of the following:
an information element identifier for identifying the information element;
a length identifier for indicating a length of the information element; and
an antenna count identifier for indicating the number of antennas of the second radio communication device.

In some embodiments, the method further includes:

performing beam forming on a carrier of each discontiguous resource unit separately if the two or more resource units allocated to the second radio communication device are discontiguous in a frequency domain.

In some embodiments, the method further includes:

combining the carriers of two or more resource units for beam forming if the two or more resource units allocated to the second radio communication device are contiguous in a frequency domain and a sum of subcarriers included in the two or more resource units is equal to a first subcarrier number.

In some embodiments, the method further includes:

performing beam forming on a carrier of each of two or more resource units separately if the two or more resource units allocated to the second radio communication device are contiguous in the frequency domain and a sum of subcarriers included in the two or more resource units is greater than or less than a first subcarrier number.

In some embodiments, the method further includes:

combining the carriers of two or more resource units for beam forming if the two or more resource units allocated to the second radio communication device are contiguous in a frequency domain.

According to a third aspect of the embodiments of the present disclosure, a communication resource unit allocation apparatus is provided and applied to a first radio communication device, including: a reception module, where

the reception module is configured to receive a message sent by a second radio communication device, and the message includes an information element indicating a number of antennas of the second radio communication device.

In some embodiments, the apparatus further includes:

a determination module configured to determine the number of resource units allocated to the second radio communication device according to the number of antennas of the second radio communication device.

In some embodiments, the determination module includes:

a first determination sub-module configured to determining, if the two or more resource units allocated to the second radio communication device are discontiguous in a frequency domain, that the number of the resource units allocated to the second radio communication device is less than or equal to the number of antennas of the second radio communication device.

In some embodiments, the determination module includes:

a second determination sub-module configured to determining, according to the number of antennas of the second radio communication device, the number of the resource units allocated to the second radio communication device in a present bandwidth.

In some embodiments, the apparatus further includes:

a first beam forming module configured to perform beam forming on a carrier of each discontiguous resource unit separately if the two or more resource units allocated to the second radio communication device are discontiguous in a frequency domain.

In some embodiments, the apparatus further includes:

a second beam forming module configured to combine the carriers of two or more resource units for beam forming if the two or more resource units allocated to the second radio communication device are contiguous in a frequency domain and a sum of subcarriers included in the two or more resource units is equal to a first subcarrier number.

In some embodiments, the apparatus further includes:

a third beam forming module configured to perform beam forming on a carrier of each of two or more resource units separately if the two or more resource units allocated to the second radio communication device are contiguous in the frequency domain and a sum of subcarriers included in the two or more resource units is greater than or less than a first subcarrier number.

In some embodiments, the apparatus further includes:

a fourth beam forming module configured to combine the carriers of two or more resource units for beam forming if the two or more resource units allocated to the second radio communication device are contiguous in the frequency domain.

In some embodiments, the information element includes at least one of the following:
an information element identifier for identifying the information element;
a length identifier for indicating a length of the information element; and
an antenna count identifier for indicating the number of antennas of the second radio communication device.

According to a fourth aspect of the embodiments of the present disclosure, a communication resource unit allocation apparatus is provided and applied to a second radio communication device, including: a sending module, where

the sending module is configured to send a message to a first radio communication device, and the message includes an information element indicating a number of antennas of the second radio communication device.

In some embodiments, the number of resource units allocated to the second radio communication device is determined according to the number of antennas.

In some embodiments, the information element includes at least one of the following:
an information element identifier for identifying the information element;
a length identifier for indicating a length of the information element; and
an antenna count identifier for indicating the number of antennas of the second radio communication device.

In some embodiments, the apparatus further includes:

a fifth beam forming module configured to perform beam forming on a carrier of each discontiguous resource unit separately if the two or more resource units allocated to the second radio communication device are discontiguous in a frequency domain.

In some embodiments, the apparatus further includes:

a sixth beam forming module configured to combine the carriers of two or more resource units for beam forming if the two or more resource units allocated to the second radio communication device are contiguous in a frequency domain and a sum of subcarriers included in the two or more resource units is equal to a first subcarrier number.

In some embodiments, the apparatus further includes:

a seventh beam forming module configured to perform beam forming on a carrier of each of two or more resource units separately if the two or more resource units allocated to the second radio communication device are contiguous in the frequency domain and a sum of subcarriers included in the two or more resource units is greater than or less than a first subcarrier number.

In some embodiments, the apparatus further includes:

an eighth beam forming module configured to combine the carriers of two or more resource units for beam forming if the two or more resource units allocated to the second radio communication device are contiguous in the frequency domain.

According to a fifth aspect of the embodiments of the present disclosure, provided is a communication device, including a processor, a transceiver, a memory, and an executable program stored on the memory and executable by the processor. The processor executes, when running the executable program, steps of the communication resource unit allocation method according to the first aspect or the second aspect.

According to a sixth aspect of the embodiments of the present disclosure, provided is a storage medium for storing an executable program. The executable program implements, when executed by a processor, the steps of the communication resource unit allocation method according to the first aspect or the second aspect.

1. A communication resource unit allocation method, applied to a first radio communication device, and comprising:
receiving a message sent by a second radio communication device, wherein the message comprises an information element indicating a number of antennas of the second radio communication device.

2. The method according to claim 1, further comprises: determining the number of resource units allocated to the second radio communication device according to the number of antennas of the second radio communication device.

3. The method according to claim 2, wherein the determining the number of the resource units allocated to the second radio communication device according to the number of antennas of the second radio communication device comprises:
determining, in response to a circumstance that the two or more resource units allocated to the second radio communication device are incontiguous in a frequency domain, that the number of the resource units allocated to the second radio communication device is less than or equal to the number of antennas of the second radio communication device.

4. The method according to claim 2, wherein the determining the number of the resource units allocated to the second radio communication device according to the number of antennas of the second radio communication device comprises:
determining, according to the number of antennas of the second radio communication device, the number of the resource units allocated to the second radio communication device in a bandwidth.

5. The method according to claims 2, further comprising: performing beam forming on a carrier of each discontiguous resource unit separately in response to a circumstance that the two or more resource units allocated to the second radio communication device are discontiguous in the frequency domain.

6. The method according to claims 2, further comprising:
in response to a circumstance that the two or more resource units allocated to the second radio communication device are contiguous in the frequency domain and a sum of subcarriers comprised in the two or more resource units is equal to a first subcarrier number, performing carry aggregation on carriers of two or more resource units and then performing beamforming.

7. The method according to claim 2, further comprising:
performing beam forming on a carrier of each of two or more resource units separately in response to a circumstance that the two or more resource units allocated to the second radio communication device are contiguous in the frequency domain and a number of subcarriers comprised in the plurality of resource units is greater than or less than a first subcarrier number.

8. The method according to claim 2, further comprising:
in response to a circumstance that the two or more resource units allocated to the second radio communication device are contiguous in the frequency domain, performing carry aggregation on carriers of two or more resource units and then performing beamforming.

9. The method according to claim 1, wherein the information element comprises at least one of the following:
an information element identifier for identifying the information element;
a length identifier for indicating a length of the information element; and
a number of antennas identifier for indicating the number of antennas of the second radio communication device.

10. A communication resource unit allocation method, applied to a second radio communication device, and comprising:
sending a message, wherein the message comprises an information element indicating a number of antennas of the second radio communication device.

11. The method according to claim 10, wherein the number of resource units allocated to the second radio communication device is determined according to the number of antennas.

12. The method according to claim 10, wherein the information element comprises at least one of the following:
an information element identifier for identifying the information element;
a length identifier for indicating a length of the information element; and
an antenna count identifier for indicating the number of antennas of the second radio communication device.

13. The method according to claim 10, further comprising: performing beam forming on a carrier of each discontiguous resource unit separately in response to that the two or more resource units allocated to the second radio communication device are discontiguous in a frequency domain.

14. The method according to claim 10, further comprising:
in response to a circumstance that the two or more resource units allocated to the second radio communication device are contiguous in a frequency domain and a sum of subcarriers comprised in the two or more resource units is equal to a first subcarrier number, performing carry aggregation on carriers of two or more resource units and then performing beamforming.

15. The method according to claim 10, further comprising:
performing beam forming on a carrier of each of two or more resource units separately in response to that the two or more resource units allocated to the second radio communication device are contiguous in a frequency domain and a sum of subcarriers comprised in the plurality of resource units is greater than or less than a first subcarrier number.

16. The method according to claim 10, further comprising:
in response to a circumstance that the two or more resource units allocated to the second radio communication device are contiguous in a frequency domain, performing carry aggregation on carriers of two or more resource units and then performing beamforming.

17. -18. (canceled)

19. A communication device, comprising a processor, a transceiver, a memory, and an executable program stored on the memory and executable by the processor, wherein the processor executes, when running the executable program, steps of the communication resource unit allocation method according to claim 1.

20. (canceled)

21. A communication device, comprising a processor, a transceiver, a memory, and an executable program stored on the memory and executable by the processor, wherein the processor executes, when running the executable program, steps of the communication resource unit allocation method according to claim 10.
